(19) United States
(12) Patent Application Publication
(10) Pub. No.: US 2006/0163128 A1
(43) Pub. Date: Jul. 27, 2006

(54) Filters

(76) Inventor: John Edgar Scragg, Durban (ZA)

Correspondence Address: STITES & HARBISON PLLC, 1199 NORTH FAIRFAX STREET, SUITE 900, ALEXANDRIA, VA, 22314, US

(21) Appl. No.: 10/522,019

(22) PCT Filed: Jul. 17, 2003
(86) PCT No.: PCT/ZA03/00094

§ 371 Date: Jan. 21, 2005

(30) Foreign Application Priority Data
Jul. 23, 2002 (ZA) 02/5863

(51) Int. Cl. B01D 17/02

(52) U.S. Cl. 210/121; 210/354; 210/356; 210/242.1; 210/123; 210/360.1

(57) ABSTRACT

A filter is disclosed which comprises a housing (46.1) having an inlet (48.1) and an outlet (50.1) and a filter cartridge (44.1) having a core (54.1). A float (56.1) in the core (54.1) has a buoyancy such that it sinks in the liquid product to be filtered and floats in a liquid which contaminates the liquid product. A seat (52.1) is provided at the upper end of the core (54.1) so that, as the level of contaminant liquid in the housing (46.1) increases, the float (56.1) rises in the core (54.1) and presses against the seat (52.1) to isolate the inlet (48.1) from the outlet (50.1) and thus flow through the filter is terminated. A drain outlet is provided at the lower end of the housing (46.1) and comprises a chamber (68) and a seat (62) against which a sealing element is pressed by a spring (66). The chamber (68) is connected to the outlet (50.1) by a pipe (70). Pressing of a vacuum release button (76) opens the chamber (68) to the atmosphere which creates a suction effect that overcomes the force of the spring (66) and allows the seat (64) to move downwards allowing liquid contaminant to exit the housing (46.1) via the pipe (70) and outlet (50.1).

### FIELD OF THE INVENTION

THIS INVENTION relates to filters.

### BACKGROUND TO THE INVENTION

Filters are used in the fuel lines of diesel and petrol engines. The filters are intended to remove contaminants such as water and solid particles. Current technology is resulting in high volume fuel flow rates, particularly in diesel engines, with the consequence that filters in use at this time are, at least in circumstances where an exceptional level of contamination occurs, unable to prevent the contaminant passing through the filter. This can cause engine damage.

The high level of fuel flow rate in a diesel engine is because the fuel is used to cool the fuel injectors. Thus most of the fuel pumped is returned to the tank and only a relatively small percentage of that pumped is consumed in the engine.

The present invention seeks to provide an improved filter for removing contaminants, both solid and liquid, from a flowing fluid product. The fluid product will normally be fuel flowing to an engine but can be another liquid product or a gas which must be delivered free of solid and liquid contaminants.

With the ever-increasing awareness of the impact of substances and contaminants on the environment, the present invention further seeks to provide means for removing the contaminants from the fuel and disposing of the contaminants in an environmentally-friendly way and without allowing the contaminants to flow out of the filter and onto the road.

### BRIEF DESCRIPTION OF THE INVENTION

According to one aspect of the present invention there is provided a filter for removing contaminants from a flowing fluid product comprising a housing having an inlet and an outlet, a filter cartridge in the housing, means for mounting the cartridge in the housing, and means for rotating the cartridge.

Said means for rotating the cartridge can be blades over which flowing fluid product passes and which apply a torque to the cartridge. Alternatively the means can be a nozzle or a series of tangentially arranged nozzles from which the fluid product flows, the reaction force as the fluid product leaves the nozzle(s) causing the cartridge to rotate.

According to a further aspect of the present invention there is provided a filter for removing contaminants from a flowing liquid product comprising a housing having an inlet and an outlet, a filter cartridge having a core, a float in the core, said float having a buoyancy such that it sinks in the liquid product to be filtered and floats in a liquid which contaminates said liquid product, and a seat against which the float presses when it floats upwards with an increasing level of contaminant liquid in the housing, contact between said float and seat isolating said inlet from the outlet and terminating flow through the filter.

According to another aspect of the invention there is provided a filter for removing fluid contaminants from a flowing liquid product comprising a housing having an inlet and an outlet, a filter cartridge in the housing, the cartridge having a hollow core, means for mounting the cartridge in the housing, means for rotating the cartridge, a float in the core, said float having a buoyancy such that it sinks in the liquid product to be filtered and floats in a liquid which contaminates said liquid product, and a seat against which the float presses when it floats upwards with an increasing level of liquid contaminant in the housing, contact between said float and seat isolating said inlet from the outlet and terminating flow through the filter.

Said float, upon contacting the seat, preferably seals off the outlet from the interior of the housing.

According to yet another aspect of the present invention there is provided a filter cartridge for removing contaminants from a flowing liquid product comprising a hollow core, filter material surrounding the core and a float which can move vertically in the core.

According to a still further aspect of the present invention there is provided a filter cartridge for removing contaminants from a flowing fluid product comprising a hollow core, a plurality of curved vanes extending outwardly from the core, each vane having a convex leading surface and a concave trailing surface and filter material packed into the depressions defined by said trailing surfaces.

The cartridge defined in the preceding paragraph can include means which, when subjected to fluid product flowing through the cartridge, produces a reaction force for rotating the cartridge. It may also include a float in the hollow core.

According to yet another aspect of the present invention there is provided a filter for removing contaminants from a flowing liquid product comprising a housing having a main inlet and a main outlet, a filter cartridge in the housing, a first float which sinks in the liquid product flowing through the housing but floats in the liquid contaminant, a first seat, said first float lifting into contact with said first seat and closing said main outlet as liquid contaminant accumulates in the housing, a drain outlet at the lower end of the housing, a valve closure element, a second seat, spring means for pressing said valve closure element into contact with said second seat thereby to close the drain outlet, a chamber, a connection between said chamber and the main outlet on the side of the first seat remote from said first float whereby suction is applied to said chamber, suction applied to said chamber exerting a force on said element to separates it from said second seat, and a second float which sinks in the liquid product flowing through the housing but floats in the liquid contaminant, said second float, when in its sunken position, closing off said drain outlet.

According to still further aspect of the present invention there is provided a filter for removing contaminants from a flowing liquid product, said filter comprising a housing having a main inlet and a main outlet, a filter cartridge in the housing, the cartridge having a hollow core which is open at both its upper end and its lower end and filter material sheathing the core, a float which sinks in the liquid product flowing through the housing but floats in liquid contaminant, said float being in said hollow core, a seat, said float lifting into contact with said seat and closing said main outlet as liquid contaminant accumulates in the housing, filter material across the open lower end of the core through which liquid contaminant can flow into said core, flow of liquid contaminant through said filter material across said open lower end of the core occurring, in use, at a faster flow rate than the flow of liquid contaminant through the filter material sheathing the core

According to yet another aspect of the present invention there is provided a filter for removing liquid contaminants from a flowing liquid product, and including absorbent material located on the underside of said housing, liquid contaminant and solid contaminants discharged from the housing, in use, flowing into said absorbent material, the liquid contaminant evaporating therefrom into the atmosphere.

The filter defined in the preceding paragraph can include a holder for said absorbent material, said holder having openings for permitting air to flow into the holder.

### BRIEF DESCRIPTION OF THE DRAWINGS

For a better understanding of the present invention, and to show how the same may be carried into effect, reference will now be made, by way of example, to the accompanying drawings in which:—

FIG. 1 is a diametral section through a filter;

FIG. 2 is a horizontal section through the filter of FIG. 1;

FIG. 3 is a section through another filter;

FIG. 4 is a section through a further filter;

FIG. 5 is a section through the upper portion of a still further filter; and

FIG. 6 is a pictorial view of a portion of the lower end of the casing of a filter and showing an evaporator.

### DETAILED DESCRIPTION OF THE DRAWINGS

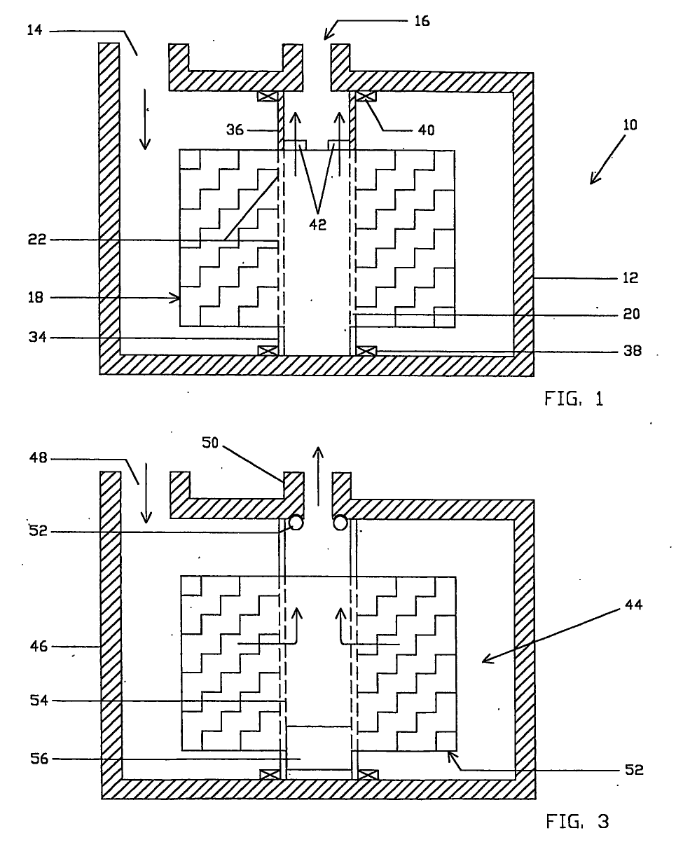

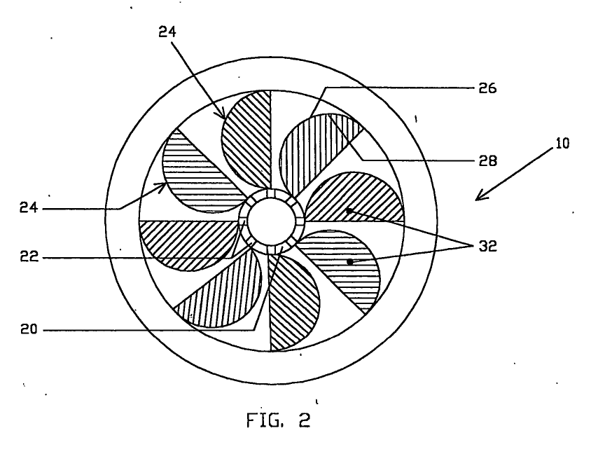

The filter 10 illustrated in FIGS. 1 and 2 comprises a cylindrical housing 12 having an inlet 14 for contaminated fluid product and an outlet 16 for filtered fluid product. Within the housing 10 there is a filter cartridge 18.

The cartridge includes a tubular core 20, the core having a plurality of holes 22 in the walling thereof; Filtered product enters the core 20 through these holes 22. A plurality of curved vanes 24 (see FIG. 2) extend outwardly from the core 20.

Each vane 24 has a convex leading face 26 and a concave trailing face 28. The concave faces 28 define depressions into which filter material 32 is packed. The filter material used currently in fuel filters is a paper which is folded to provide a series of layers, and this type of filter material can be packed into the depressions.

The core 20 is extended in each direction by spigots 34, 36. These spigots run in bearings 38, 40 carried by the housing 12. The spigot 36 carries a plurality of blades 42 over which the filtered product flowing from the core 20 to the outlet 16 passes. The blades 42 are so orientated that the flowing product produces a reaction force which rotates the cartridge 18 in the bearings 38, 40.

The blades 42 can be replaced by a nozzle which is directed tangentially with respect to the axis of rotation of the cartridge. Fuel flowing from the nozzle causes a reaction force which rotates the cartridge. Two or more nozzles can be used.

The blades 42 or nozzle(s) can be carried by the cartridge. Alternatively they can be carried by a rotatable part of the housing and there can be means for rendering the cartridge fast with the rotatable part of the housing.

In use contaminated product enters the housing 12 via the inlet 14 and flows into the cartridge 18. After passing through the filter medium the filtered product flows into the core 20, through the spigot 36 and thus reaches the outlet 16. The product flowing over the blades 42 causes the cartridge 18 to rotate in the bearings 38, 40.

The concave front surfaces of the vanes 24 throw solid contaminants outwardly towards the housing's cylindrical wall thus keeping them from the filter material 32 behind the vanes:

The vanes 24 can be inclined so that, in the direction of rotation, the upper part of the vane leads the lower part. This imparts a downward component to the force applied to the solid particles thus assisting in accumulating them in the lower part of the housing.

The housing 12 can have a manually operated drain or an automatic drainage system as illustrated in FIG. 4 etc.

The fluid product which flows through the filter of FIGS. 1 and 2 is normally a liquid in which event the contaminant removed comprises solid particles. However, the fluid product can be a gas in which event the contaminant removed can be a solid or a liquid.

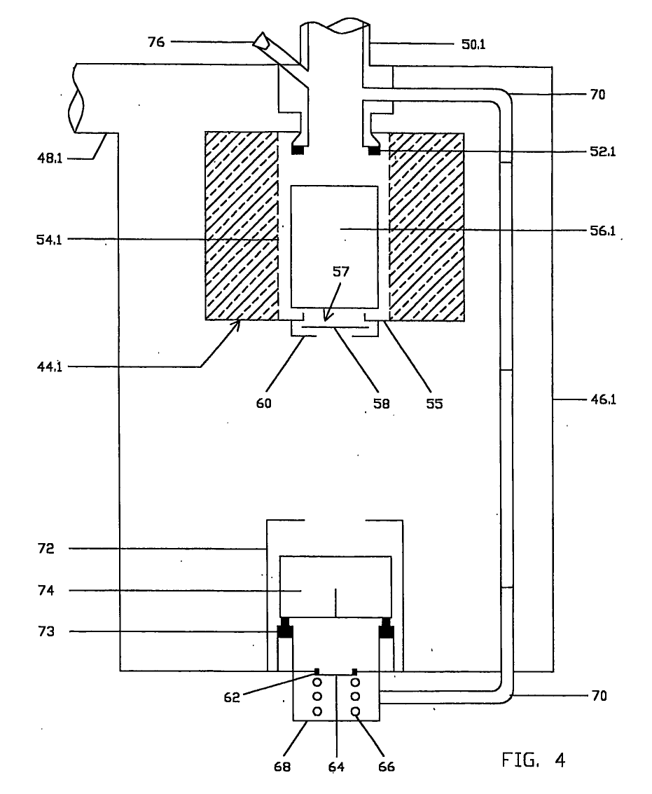

Turning now to FIG. 3, the cartridge 44 illustrated is within a housing 46 having a contaminated liquid product inlet 48 and a filtered liquid product outlet 50. The cartridge 44 has a perforated core 54 with a float 56 in the core. The float 56 has a buoyancy such that it sinks in the liquid to be filtered but floats in the liquid contaminant. Normally the liquid to be filtered is diesel or petrol (gasoline) and the contaminant water and solid particles.

The outlet 50 is encircled by a valve seat 52. As the level of the water removed from the contaminated product rises, the float 56 floats upwardly in the core 54. Eventually the float 56 is pressed against the seat 52 thus preventing water retained in the housing 46 from leaving the housing via the outlet 50 and reaching the engine.

The rotary filter of FIGS. 1 and 2 can be provided with a float as described with reference to FIG. 3, and the filter of FIG. 3 can be provided with a manually operable drain or with an automated drainage system as illustrated in FIG. 4 etc. The cartridges 18 and 44 can be disposable.

The housing 12 can have a manually operated drain tap or can have an automatic water dumping system such as is described hereinafter with reference to FIG. 4.

Referring now to FIG. 4, this shows a further form of filter. Where applicable like-parts have been designated with the same reference numerals as used in FIG. 3 with the addition of the suffix .1.

The lower end of the core 54.1 is constituted by an annular end plate 55 which bounds a central opening 57. There is, below the open lower end of the core 54.1, a disc 58 which is held in place by a holder 60.

At the lower end of the housing 46.1 there is a drainage outlet comprising a valve seat 62, a valve closure element 64 and a coil spring 66 which normally presses the element 64 against the seat 62.

The spring 66 is in a chamber 68 which is connected by a pipe 70 to the outlet 50.1. The element 64 is constituted by a flexible diaphragm forming part of the wall of the chamber 68. Thus suction at the outlet 50.1 is applied to the chamber 68 thereby to suck the element 64 away from the seat 62.

A cage 72 is provided above the seat 62, there being a float 74 in the cage 72. The float 74 co-operates with a valve seat 73.

A vacuum release button 76 is provided for connecting the inlet 50.1 to atmosphere and allowing air to flow in.

The fuel entering through the inlet 48.1 is usually contaminated with water. The fuel passes through the filter cartridge 44.1 and exits through the outlet 50.1. The removed water accumulates in the bottom of the housing 46.1 and initially causes the float 74 to lift away from the valve seat 73 so that only the element 64 pressed onto the seat 62 by the spring 66 prevents liquid from flowing out. Because there is little in the way of vacuum applied to the chamber 68, the spring 66 is able to hold the element 64 against the seat 62 and thus the water drainage outlet remains closed.

As the water level rises, the float 56.1 moves upwardly into contact with the seat 52.1 and flow of fuel through the filter to the engine ceases.

It will be understood that fuel being sucked through the filter pulls the disc 58 against the lower end of the cartridge 44.1 and closes off the lower end of the core 54.1.

Once flow through the filter is interrupted by the float 56.1, the suction effect in the outlet 50.1 is greatly increased and this is applied through the pipe 70 to the chamber 68. The suction effect is such that the downward force exerted on the element 64 overcomes the upward force of the spring 66 and the drainage opening at the lower end of the housing 46.1 thus opens. The water level in the housing commences to drop as drainage takes place through the drainage outlet.

As soon as flow through the filter ceased, the element 58 dropped away from the lower end of the core 54.1. Hence water is able to flow from the core 54.1 around the element 58 and out through the drainage outlet.

As the water level approaches the lower end of the housing 46.1, the sinking float 74 abuts the seat 73 and seals-off the drainage outlet before fuel can emerge. The element 64, however, remains spaced from the seat 62 in view of the fact that the float 56.1 is still sucked against the seat 52.1, and the vacuum condition has not been broken.

When the vacuum release button 76 is pressed, air flows into the outlet 50.1. The float 56.1 is thus no longer sucked against the seat 52.1 and it drops back to the bottom of the core 54.1. Simultaneously the sub-atmospheric pressure in the chamber 68 increases and the spring 66 is able to overcome the vacuum derived force. The element 64 thus re-seats and the drainage outlet is closed.

In a modified form the reset button 76 is omitted and the float 56.1 has a bore through it from top to bottom. When the float 56.1 lifts into engagement with the seat 52.1, the engine draws a vacuum in the outlet 50.1 before fuel starvation shuts it down. Depending on the size of the bore in the float, fuel flows at a predetermined rate through the float and the vacuum condition is relieved. By adjusting the size of the bore, the time for which the drainage outlet is held open can be adjusted. A filter of this type is fully automatic and does not require driver intervention to restart flow of fuel.

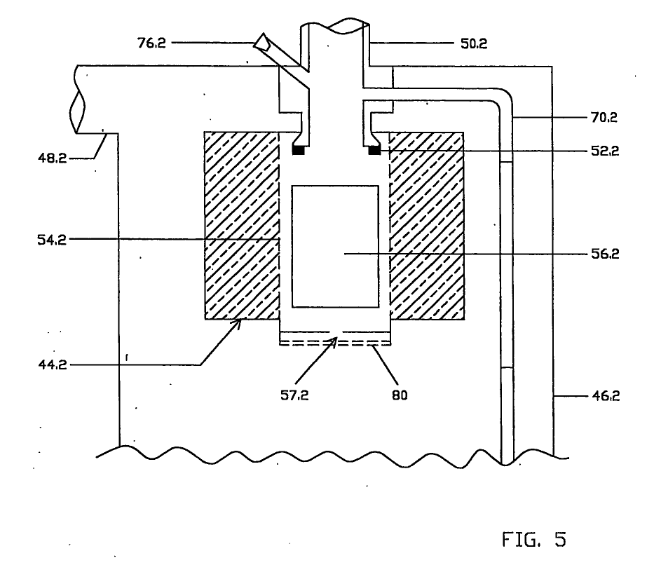

Referring now to FIG. 5, a still further form of filter is shown. Where applicable, like-parts have been designated with the same reference numerals as used in FIGS. 3 and 4 with the addition of the suffix 0.2.

An opening 57.2 at the lower end of the core 54.2 is smaller in FIG. 5 than it is in FIG. 4. Below the opening 57.2 there is filter material 80 in the form of a screen or membrane. A drainage outlet, as illustrated in FIG. 4, but not shown in FIG. 5, is provided at the lower end of the housing 46.2 and connects to the outlet 50.2 via a pipe 70.2.

Fuel entering through the inlet 48.2 is usually contaminated with water. The fuel passes through the filter cartridge 44.2 and exits through the outlet 50.2. The removed water accumulates in the bottom of the housing 46.2.

The resistance to fluid flow through the filter material 80 is lower than through the filter cartridge 44.2. Therefore, as the water level in the housing 46.2 rises to the bottom of the filter cartridge 44.2, the water is first drawn into the core 54.2 through the filter material 80 via the opening 57.2. The water flowing into the core 54.2 via the opening 57.2 causes the float 56.2 to lift prior to water being drawn into the core 54.2 through the filter cartridge 44.2. This ensures that the float 56.2 is rising above the level of the water that is ingressing into the core 54.2 through the filter cartridge 44.2. This situation prevents any water from exiting the filter cartridge 44.2 via the outlet 50.2 prior to the float 56.2 engaging the seat 52.2.

As the water level rises, the float 56.2 moves upwardly into contact with the seat 52.2 and flow of fuel through the filter cartridge 44.2 to the engine ceases.

The removal of liquid contaminant from the filter of FIG. 5 is the same as described above in relation to the filter of FIG. 4.

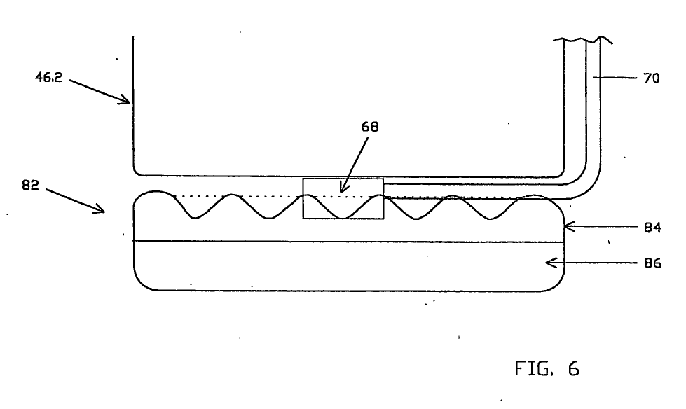

Referring now to FIG. 6, an evaporator, generally designated 82, is fitted to the lower end of the housing 46.2. The evaporator 82 comprises a holder 84 which contains absorbent material 86. The holder 84 has openings (not shown) in it which permit air to flow over and through the absorbent material 86. The evaporator 82 is fitted by means of a clip or bolts (not shown), or any other suitable attachment means.

Water and other contaminants in liquid form are absorbed by the material 86 during manual or automatic drainage. Any solid contaminants are entrained within the material 86. Airflow over the absorbent material 86 as well as through the absorbent material 86, allows the removed liquid contaminants to evaporate into the atmosphere.

The evaporator 82 thus allows for the removal of contaminants from the fuel, without disposing of the contaminants onto the road surface.

1. A filter for removing contaminants from a flowing fluid product, said filter comprising a housing having an inlet and an outlet, a filter cartridge in the housing, means for mounting the cartridge in the housing, and means for rotating the cartridge.

2. A filter as claimed in claim 1, wherein said means for rotating the cartridge comprises blades over which the fluid product passes and which apply a torque to the cartridge.

3. A filter as claimed in claim 1, wherein said means for rotating the cartridge is a nozzle from which the fluid product flows, the reaction force as the fluid product leaves the nozzle causing the cartridge to rotate.

4. A filter as claimed in claim 1, wherein said means for rotating the cartridge is a series of tangentially arranged nozzles from which the fluid product flows, the reaction force as the fluid product leaves the nozzles causing the cartridge to rotate.

5. A filter for removing contaminants from a flowing liquid product, said filter comprising a housing having an inlet and an outlet, a filter cartridge having a core, a float in the core, said float having a buoyancy such that it sinks in the liquid product to be filtered and floats in a liquid which contaminates said liquid product, and a seat against which the float presses when it floats upwards with an increasing level of contaminant liquid in the housing, contact between said float and seat isolating said inlet from the outlet and terminating flow through the filter.

6. A filter for removing contaminants from a flowing liquid product, said filter comprising a housing having an inlet and an outlet, a filter cartridge in the housing, the cartridge having a hollow core, means for mounting the cartridge in the housing, means for rotating the cartridge, a float in the core, said float having a buoyancy such that it sinks in the liquid product to be filtered and floats in a liquid which contaminates said liquid product, and a seat against which the float presses when it floats upwards with an increasing level of liquid contaminant in the housing, contact between said float and seat isolating said inlet from the outlet and terminating flow through the filter.

7. A filter as claimed in claims 5 or 6, wherein said float, upon contacting the seat, seals off the outlet from the interior of the housing.

8. A filter cartridge for removing contaminants from a flowing liquid product, said filter cartridge comprising a hollow core, filter material surrounding the core and a float which can move vertically in the core.

9. A filter cartridge for removing contaminants from a flowing fluid product, said filter cartridge comprising a hollow core, a plurality of curved vanes extending outwardly from the core, each vane having a convex leading surface and a concave trailing surface and filter material packed into the depressions defined by said trailing surfaces.

10. A filter cartridge as claimed in claim 9 and including means which, when subjected to fluid product flowing through the cartridge, produces a reaction force for rotating the cartridge.

11. A filter cartridge as claimed in claims 9 or 10, and including a float in the hollow core.

12. A filter for removing contaminants from a flowing liquid product, said filter comprising a housing having a main inlet and a main outlet, a filter cartridge in the housing, a first float which sinks in the liquid product flowing through the housing but floats in the liquid contaminant, a first seat, said first float lifting into contact with said first seat and closing said main outlet as liquid contaminant accumulates in the housing, a drain outlet at the lower end of the housing, a valve closure element, a second seat, spring means for pressing said valve closure element into contact with said second seat thereby to close the drain outlet, a chamber, a connection between said chamber and the main outlet on the side of the first seat remote from said first float whereby suction is applied to said chamber, suction applied to said chamber exerting a force on said element to separate it from said second seat, and a second float which sinks in the liquid product flowing through the housing but floats in the liquid contaminant, said second float, when in its sunken position, closing off said drain outlet.

13. A filter for removing contaminants from a flowing liquid product, said filter comprising a housing having a main inlet and a main outlet, a filter cartridge in the housing, the cartridge having a hollow core which is open at both its upper end and its lower end and filter material sheathing the core, a float which sinks in the liquid product flowing through the housing but floats in liquid contaminant, said float being in said hollow core, a seat, said float lifting into contact with said seat and closing said main outlet as liquid contaminant accumulates in the housing, filter material across the open lower end of the core through which liquid contaminant can flow into said core, flow of liquid contaminant through said filter material across said open lower end of the core occurring, in use, at a faster flow rate than the flow of liquid contaminant through the filter material sheathing the core.

14. A filter as claimed in any one of claims 1 to 7, 12 and 13, and including absorbent material located on the underside of said housing, liquid contaminant and solid contaminants discharged from the housing, in use, flowing into said absorbent material, the liquid contaminant evaporating therefrom into the atmosphere.

15. A filter as claimed in claim 14, and including a holder for said absorbent material, said holder having openings for permitting air to flow into the holder.
